(19) United States
(12) Patent Application Publication
(10) Pub. No.: US 2013/0266472 A1
(43) Pub. Date: Oct. 10, 2013

(54) Method of Coating Metal Powder with Chemical Vapor Deposition for Making Permanent Magnets

(71) Applicant: Yucong Wang, West Bloomfield, MI (US)

(72) Inventor: Yucong Wang, West Bloomfield, MI (US)

(73) Assignee: GM GLOBAL TECHNOLOGY OPERATIONS LLC, DETROIT, MI (US)

(21) Appl. No.: 13/439,442

(22) Filed: Apr. 4, 2012

(51) Int. Cl. H01F 41/02; B22F 1/02

(52) U.S. Cl. 419/35; 419/64

(57) ABSTRACT

A method of making a permanent magnet includes a step of contacting a powder with a metal-containing vapor to form a coating on the powder. The alloy powder includes neodymium, iron, and boron. The metal-containing vapor includes a component selected from the group consisting of dysprosium, terbium, iron and alloys thereof. A permanent magnet is formed from the coated powder by compaction, sintering and subsequent heat treatment.

### FIELD OF THE INVENTION

In at least one aspect, the present invention relates to an alloy coating powder for making permanent magnets with improved magnetic properties and reduced use of dysprosium and/or terbium. In particular, the present invention relates to improved and less expensive methods of making coated powders for producing permanent magnets

### BACKGROUND

Permanent magnets are used in various areas such as microelectronics, automobiles, medical devices, power generation, and the like. Permanent magnets are typically formed from hard magnetic materials which also find applications in the automotive, aerospace and telecommunication industries. Rare earth magnets, such as Nd—Fe—B, have a higher energy density than other hard magnets. Moreover, such magnets are used in automotive applications such as starters, small motors, alternators, sensors, meters, and electric and hybrid vehicle propulsion systems.

Rare earth magnets are usually made from powder metals by forming to shape under pressure and then sintering. The overwhelming majority of hard magnets are formed from ferrite and Nd—Fe—B. Ferrite is less expensive but with only modest magnetic properties. This material is mainly used in applications where size and weight are not main design considerations.

The intrinsic properties necessary for high strength permanent magnets include a high saturation magnetization, large magnetocrystalline anisotropy, and a reasonable high Curie temperature. These properties are strongly influenced by extrinsic factors such as the microstructure. The material properties (e.g. the magnetic properties) that are influenced by the microstructure include phases, grain size, grain morphology, and orientation. When the grain size is below a critical limit known as the single domain limit, demagnetization is much more difficult, leading to excellent hard magnetic properties. The single domain limit is related to specific intrinsic magnetic properties, including the anisotropy constant and the saturation magnetization. For Nd—Fe—B magnets, the single domain limit is about 300 nm.

The preferred commercial technique to generate a fine-scale microstructure is melt spinning Depending on the processing parameters, melt spinning generates a microstructure that ranges from fine, equiaxed grains on the order of 20-30 nm to an amorphous structure that crystallizes during solidification. However, it is critical to retain as fine a microstructure as possible upon further processing to optimize the magnetic properties. Anisotropic magnets are produced with grains in preferred crystallographic alignment. High degree of crystallographic alignment results in high energy products. The degradation in the microstructure and the limited crystallographic alignment achievable limits commercially available energy products to about 50 megagauss-oersteds (MGOe), comparing to the theoretical maximum of 64 MGOe.

Sintered Nd—Fe—B permanent magnets have very good magnetic properties at low temperatures. After magnetization, permanent magnets are in a thermodynamically non-equilibrium state. Any changes in the external conditions, in particular the temperature, result in a transition to another more stable state. These transitions are typically accompanied by changes in the magnetic properties. Due to the low Curie temperature of the Nd₂Fe₁₄B phase, the magnetic remanence and intrinsic coercivity decrease rapidly with increased temperature. There are two common approaches for improving the thermal stability of Nd—Fe—B permanent magnets and for increasing magnetic properties in order to obtain compact, lightweight, and powerful motors for hybrid and electrical vehicles. One approach is to raise the Curie temperature by adding Co, which is completely soluble in the Nd₂Fe₁₄B phase. However, the coercivity of the Nd—Fe—B magnets with Co decreases, possibly because of the nucleation sites for reverse domains. The second approach is to add heavy rare-earth elements. It is known that the substitution of dysprosium for neodymium or iron in Nd—Fe—B magnets results in increases of the anisotropic field and the intrinsic coercivity, and a decrease of the saturation magnetization (C.S. Herget, Metal, Poed. Rep. V. 42, P.438 (1987). W. Rodewald, J. Less-Common Met., V111, P77 (1985). D. Plusa, J. J. Wystocki, Less-Common Met. V. 133, P.231 (1987)). It is believed that once a nucleus of reversed domain appears at the surface of the grain, magnetic reversal of the whole grain occurs immediately. Reverse magnetic domain only comes from the grain boundary. If we can make dysprosium (Dy) uniformly distributed around the grain boundary, the coercivity should be increased, and the remanence should not change much. Therefore, it is a common practice to add the heavy rare-earth metals such as dysprosium (Dy) or terbium (Tb) into the mixed metals before melting and alloying. However, Dy and Tb are very rare and expensive. Heavy REs contain only about 2-7% Dy. The price of Dy has increased sharply in recent times. Tb is needed if even higher magnetic properties are required, and it is much more expensive than Dy.

The ideal microstructure for sintered Nd—Fe—B based magnets is Fe₁₄Nd₂B grains perfectly isolated by the nonferromagnetic Nd-rich phase (a eutectic matrix of mainly Nd plus some Fe₄Nd_{1.1}B₄ and Fe—Nd phases stabilized by impurities). The addition of Dy and/or Tb leads to the formation of different ternary intergranular phases based on Fe, Nd and Dy or Tb. These phases are located in the grain boundary region and at the surface of the Fe₁₄Nd₂B grains.

Any addition of elements to improve the magnetic property should fulfill the following conditions: 1) the intermettalic phase should be nonferromagnetic to separate the ferromagnetic grains; 2) the intermetallic phase must have a lower melting point than the Nd₂Fe₁₄B phase to produce a dense material via liquid phase sintering; and 3) the elements should have a low solubility in Nd₂Fe₁₄B to keep good magnetic properties. The coercivity is known to be greatly influenced by the morphology of the boundary phases between Nd₂Fe₁₄B grains.

Accordingly, there is a need for improved methods of making permanent magnets such as Nd—Fe—B permanent magnets.

### SUMMARY OF THE INVENTION

The present invention solves one or more problems of the prior art by providing in at least one embodiment, a method of making a permanent magnet. The method comprises a chemical vapor deposition (CVD) step of contacting a powder with a metal-containing vapor to form a coating on the powder. The alloy powder includes neodymium, iron, and boron. The metal-containing vapor includes a component selected from the group consisting of dysprosium, terbium, iron and alloys thereof. A permanent magnet is formed from the coated powder by compaction, sintering and subsequent heat treatment.

In another embodiment, a method of making a permanent magnet is provided. The method comprises a CVD step of contacting a powder with a metal-containing vapor to form a coating on the powder, the powder including neodymium, iron, and boron. The metal-containing vapor includes a component selected from the group consisting of dysprosium, terbium, iron and alloys thereof. The powder and/or the metal-containing vapor is irradiated with light to induce coating of the powder. A permanent magnet is formed from the coated powder.

CVD processes have a number of important advantages over physical vapor deposition (PVD) processes. CVD processes are typically faster, not line-of-sight deposition, allow for thicker coatings, and are more economical. CVD equipment is relatively simple, does not require ultrahigh vacuum, and generally can be adapted to many process variations. However, its applications are limited to substrates that are thermally stable at high temperatures without the introduction of plasma (600° C. or higher).

### BRIEF DESCRIPTION OF THE DRAWINGS

Exemplary embodiments of the present invention will become more fully understood from the detailed description and the accompanying drawings, wherein:

FIG. 1 is a flow chart illustrating a method of making a permanent magnet;

FIG. 2 is a schematic illustration of a chemical vapor deposition system utilizing microwave energy;

FIG. 3 is a schematic illustration of a chemical vapor deposition system utilizing light (photo-laser CVD) to induce coating formation; and

FIG. 4 is a schematic illustrating the operation of a thermal-laser CVD system.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

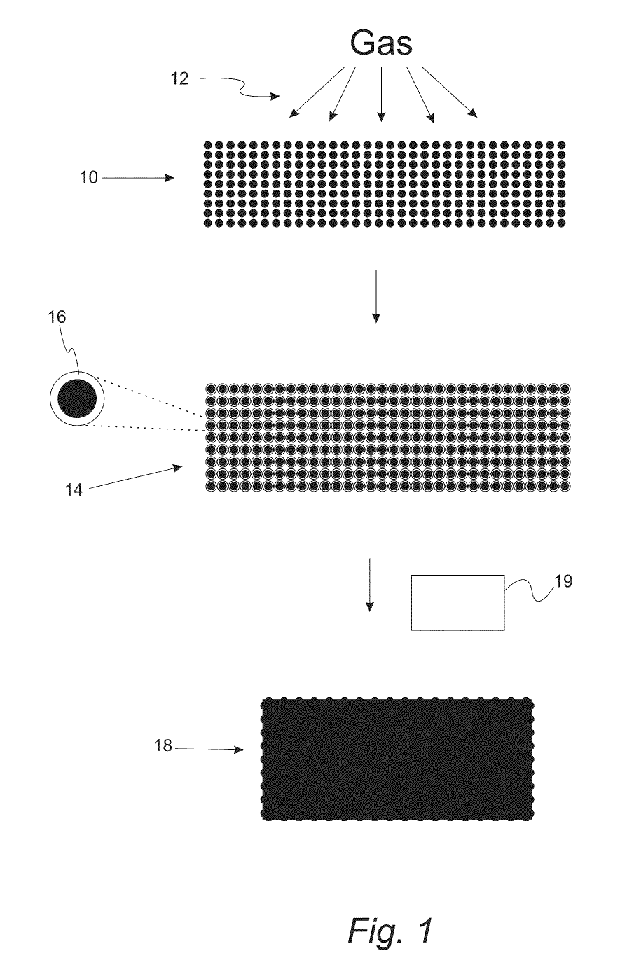

With reference to FIG. 1, a flow chart illustrating a method of making a permanent magnet is provided. The method comprises a chemical vapor deposition step in which alloy powder 10 is contacted with metal-containing vapor 12 to form coated powder 14 in which coating 16 is disposed on the particles of the alloy powder. In various refinements, the CVD step may be thermally activated, photo-activated/assisted, microwave activated, or combinations thereof. In the CVD process, coating 16 is formed on the heated alloy powder by vapor transport and chemical reaction from the gas phase. In one refinement, the substrate is heated to a temperature from about 300 to about 1100° C. Typically, the deposition species are ions, atoms and/or molecules, or a combination thereof. The alloy powder includes neodymium, iron, and boron. In a particularly useful refinement, the metal-containing vapor is contacted with a plasma (formed by microwave or radio frequency radiation) to induce coating of the powder. In a refinement, the coating has a thickness from about 10 nm to about 100 microns. In another refinement, the coating has a thickness from about 100 nm to about 10 microns. In still another refinement, the coating has a thickness from about 30 nm to about 3 microns. The metal-containing vapor includes a component selected from the group consisting of dysprosium, terbium, iron and alloys thereof. Permanent magnet 18 is formed from the coated powder after compacting in a mold, sintering and heat treating. In a refinement, the coated powder is shaped by placing the powder combination into mold 19. The powder combination is usually pressed during or after shaping. Typically, permanent magnet includes from about 0.01 to about 8 weight percent dysprosium and/or terbium of the total weight of the permanent magnet. However, the surface concentration of dysprosium and/or terbium may be from about 2 to about 50 weight percent of the total weight of the coating layer.

Magnets made using the present process use considerably less Dy or Tb than those made using conventional prior art methods while obtaining similar magnetic properties. In the present process, the Dy or Tb coated Nb—Fe—B powders are used to make a magnet that has a much higher distribution of Dy or Tb in grain boundaries, which can be seen and measured using a scanning electron microscope with a microprobe. Conventional methods employ Nb—Fe—B powders with Dy or Tb as alloying elements where typically, the Dy or Tb are uniformly distributed microscopically. The present invention utilizes a non-uniform distribution of these elements which enables the present process to use much less Dy or Tb for the similar magnetic properties. For example, the amount of Dy and/or Tb can be reduced by about 20% or more compared to conventional processes, or about 30% or more, or about 40% or more, or about 50% or more, or about 60% or more, or about 70% or more, or about 80% or more, or about 90% or more.

As set forth above, the coating process of the present embodiment allows the average Dy or Tb concentration to be reduced and changes the distribution of the Dy or Tb in the magnet. The average Dy or Tb concentration can be in a range of about 0.3 to about 5 wt %, or about 0.3 to about 4 wt %, or about 0.3 to about 3 wt %, compared with about 6-9 wt % for traditional magnets having similar high magnetic properties. The coating process creates powder particles with a Dy or Tb surface concentration as high as about 5 to about 80 wt. % or more, and a low Dy or Tb bulk concentration. In this context, surface concentration refers to the weight percent of Dy and/or Tb in the layer coating the alloy powder. The coating process is introduced into the current preparation for the powder metallurgy process as an extra step.

In a variation of the present embodiment, the alloy powder is formed as follows. An alloy containing neodymium, iron, and boron is melted and cast via spinning to make strips. The alloy strips are then hydrogen decrepitated by hydrogenating the alloy. Typically, this step is accomplished in a hydrogen furnace at a pressure of approximately 1 to 5 atm until the alloy is deprecated. The alloy is then typically dehydrogenated in a vacuum at elevated temperature (e.g., 300 to 600° C.) for 1 to 10 hours. The result of the hydrogenation and dehydrogenation is that the alloy is decrepitated into a coarse powder typically with an average particle size from 1 mm to 4 mm. The coarse powder is then pulverized (by nitrogen jet milling) to make a starting powder with average particle size of 1 to 4 microns. In a refinement, the alloy powder may be optionally screened and then mixed with a second alloy powder in order to adjust the chemical composition. The alloy powder is then coated by a chemical vapor deposition process with a Dy and/or Tb containing layer. The resulting coated powder may then be again optionally screened.

In another variation of the present embodiment, the coated powder is formed into a permanent magnet. In one refinement, magnets are formed by a powder metallurgy process. Such processes typically involve weighing and pressing under magnetic field for powder alignment (vacuum bagging), isostatic pressing, sintering in a mold, aging (e.g., about 30 hrs, at about 800 C to about 1100° C. with various temperature stages, in vacuum) and machining to the final magnet pieces. Finally, the magnets are usually surface treated (e.g., phosphate, electroless nickel plating, epoxy coating, etc.).

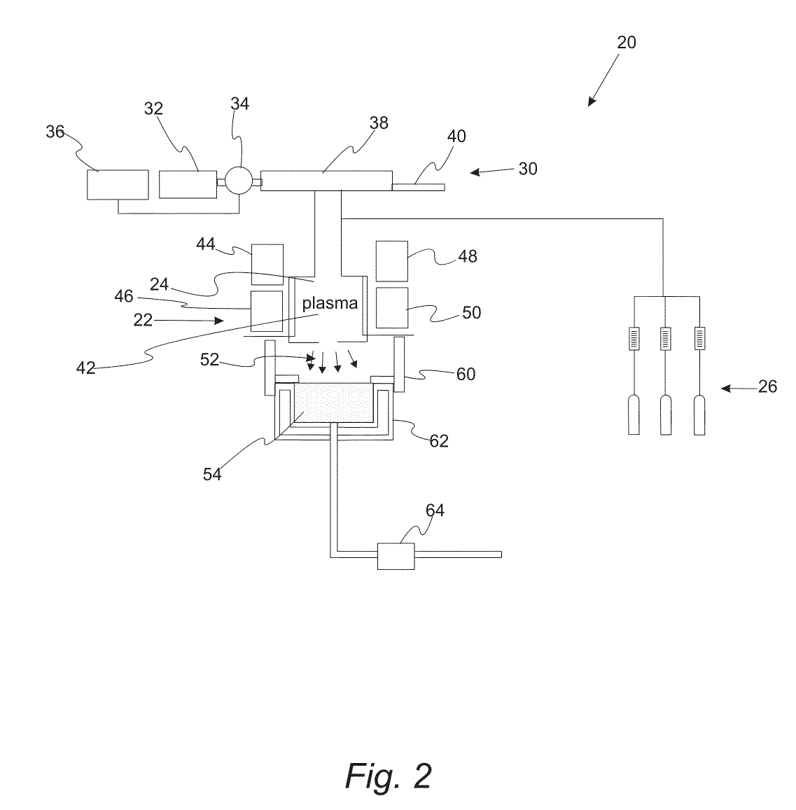

With reference to FIG. 2, a schematic illustration of a chemical vapor deposition system utilizing microwave energy is provided. CVD deposition system 20 includes chamber 22 which includes gas reaction zone 24 which receives metal-containing reactant gases from gas delivery system 26. The metal-containing reactant gases are exposed to microwave radiation derived from microwave system 30. Microwave system 30 includes magnetron 32, circulator 34, and power supply 36. Microwave system 30 also includes microwave feed 38 and short circuiting slide 40. The microwave radiation induces the formation of reactive plasma 42. CVD deposition system 20 also includes magnets 44, 46, 48, 50 that intensify reactive plasma 42. Activated metal-containing gas 52 is formed from reactive plasma 42. The introduction of plasma greatly reduces the required deposition temperature and improves its deposition speed (from 800-1100 C to 300-700 C). The numerous chemical reactions can be used in this CVD process. A CVD reaction is controlled by the following factors: thermodynamic, mass transport and kinetic considerations, chemistry of the reaction, and processing parameters of temperature, pressure and chemical activity. A theoretical analysis (or computer modeling) of these factors is used to predict the reaction mechanism (i.e., the path of the reaction as it forms the deposit), the resulting composition of the deposit (i.e., its stoichiometry), and the structure of the deposit (i.e., the geometric arrangement of its atoms). This analysis may provide guidelines for choosing the appropriate CVD parameters. Numerous computational fluid-dynamic codes are available to design reactors that maximize the possible yields from a given reaction which is often kinetically controlled. Various plasma mechanisms can be used in this CVD process. As an example, the microwave glow discharge is used at a standard frequency of 2.45 GHz as illustrated in FIG. 2. Plasma CVD systems can also use radio frequency (RF) with operating frequencies of 450 KHz to 113.56 MHz. Other plasma producing techniques may include electron cyclotron resonance (ECR) and the proper combination of an electric field and a magnetic field. Cyclotron resonance is achieved when the frequency of the alternating electric field matches the natural frequency of the electrons orbiting the lines of force of the magnetic field.

Still referring to FIG. 2, activated metal-containing gas 52 contacts alloy powder 54 thereby inducing coating of the powder. Alloy powder 54 is a loose structure so that the powder surfaces can be evenly coated. In a refinement, alloy powder 54 includes neodymium, iron, and boron and activated metal-containing gas 52 (as well as metal-containing reactant gases from gas delivery system 26) includes a component selected from the group consisting of dysprosium, terbium, iron and alloys thereof. CVD deposition system 20 also includes heaters 60 for heating activated metal-containing gas 52 and water cooling jacket 62 for cooling alloy powder 54 and the reacting gases. Typically, the processing temperatures are in the range of 300 to 700° C. and the pressures are from 0.5 to 10 mTorr. In a refinement, the pressure is from 1 to 3 mTorr. CVD deposition system 20 also includes vacuum system 64 for maintaining the system at reduced pressure and for venting spent reactant gases.

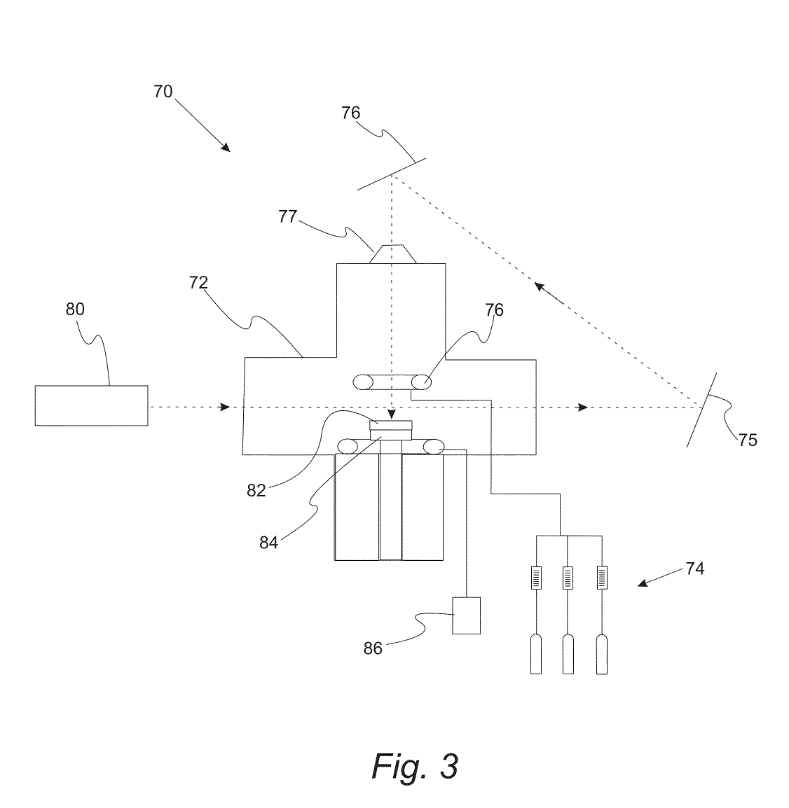

With reference to FIG. 3, a schematic illustration of a chemical vapor deposition system utilizing light (photo-laser CVD) to induce coating formation is provided. Deposition system 70 includes deposition chamber 72. Reactant gases which provide a metal-containing vapor are introduced into deposition chamber 72 from gas delivery system 74 via inlet nozzle 76. Light source 80 is used to introduce light into deposition chamber 72 in order to induce reaction of the reactant gases. Typically, light source 80 is a laser light source. In a refinement, light source 80 provides ultraviolet light to induce/initiate coating of alloy powder 82. FIG. 3 also illustrates mirrors 75, 76 and window 77. Ultraviolet light has sufficient photon energy to break the chemical bonds in the reactant molecules. These molecules have a broad electronic absorption band and are readily excited by UV radiation. The photon energies range from 3.4 eV to 6.4 eV. Photo-laser CVD differs from thermal-laser CVD in that it does not require heat, because the reaction is photon-activated, and the deposition essentially occurs at room temperature. However, its deposition rate is slow compared with thermal-laser CVD. In a refinement, the introduced light contact both the metal-containing vapor and/or the alloy powder 82 which is the substrate. In a refinement, alloy powder 82 includes neodymium, iron, and boron and the metal-containing vapor includes a component selected from the group consisting of dysprosium, terbium, iron and alloys thereof. Therefore, alloy powder 82 is ultimately coated with a layer that includes dysprosium, terbium, iron and alloys thereof. Optional heater 84 is used to heat alloy powder 82, typically to temperatures from 200 to 600° C. Vacuum system 86 is used to maintain a reduced pressure in chamber 72 and to evacuate spent reactant gases. In a refinement, the reaction pressures are from about 1 Torr to 1 atm. In another refinement, the reaction pressures are from about 1 Torr to about 100 Torr. In still another refinement, the reaction pressures are from about 0.001 mTorr to about 30 mTorr.

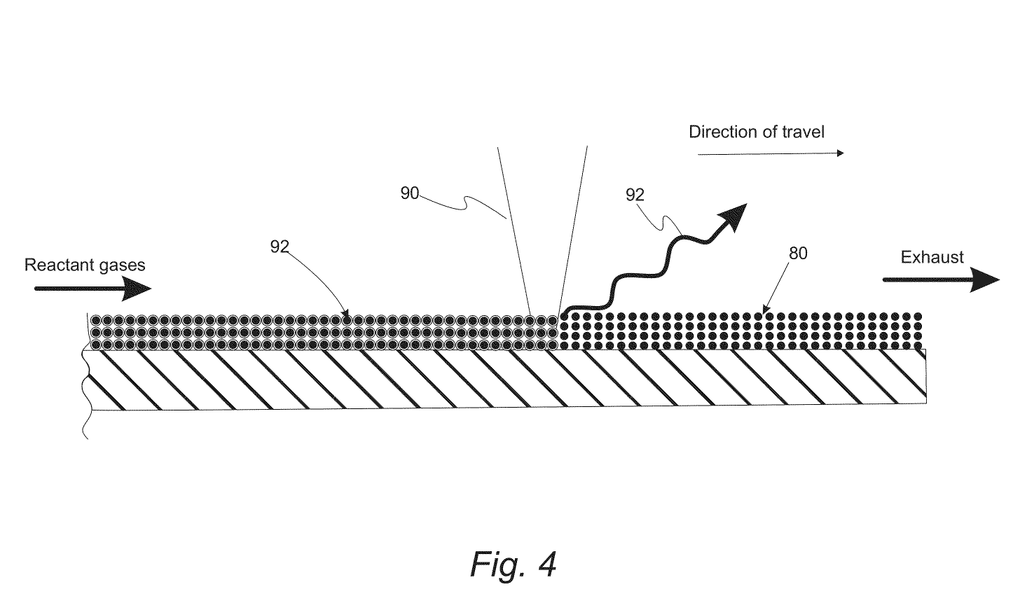

With reference to FIG. 4, a schematic illustrating the operation of a thermal-laser CVD system is provided. In this variation, alloy powder 80 is coated via the action of light beam 90 which contacts and thereby heats the powder to form coated powder 92 with gas byproducts being liberated and ultimately exhausted. The wavelength of the laser can be such that little or no energy is absorbed by gas molecules. Because the substrate is locally heated, deposition is restricted to the heated area. In a refinement, the substrate temperature are from about 25° C. to about 300° C. In a refinement, the light beam or substrate moves such that a strip of the alloy powder substrate is coated. In a refinement, the reaction pressures are from about 1 Torr to 1atm. In another refinement, the reaction pressures are from about 1 Torr to about 100 Torr. In still another refinement, the reaction pressures are from about 0.001 mTorr to about 30 mTorr.

The various embodiments set forth above utilize a metal-containing vapor as a coating precursor. In one refinement, the metal-containing vapor comprises a component selected from the group consisting of DyCl₃, TbCl₃, DyF₃, Dy₂S₃, TbF₃, Tb₂S₃, DyBr₃, TbBr₃, DyI₃, TbI₃, Dy(2,2,6,6-tetramethyl-3,5-heptanedione)₃, Tb(2,2,6,6-tetramethyl-3,5-heptanedione)₃, pi-arene Dy complexes, and pi-arene Tb complexes. For example, dysprosium can be deposited with numerous chemical reactions, such as hydrogen reduction of chloride or fluoride compounds, as well as the following chemical reactions:

2DyCl₃+3H₂→2Dy+6HCl

2DyCl₃→2Dy+3Cl₂

DyCl₂→Dy+Cl₂

2DyF₃+3H2→2Dy+6HF

Dy₂S₃→2Dy+3S₂

Dy₂(CO₃)₃+6HCl(aq)→2DyCl₃(aq)+3CO₂(g)+3H₂O(l).

It is readily appreciated that similar reactions may be applied to dysprosium sulfate Dy₂(SO₄)₃.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a magnet, the method comprising:
contacting a powder with a metal-containing vapor to form a coated powder, the powder including neodymium, iron, and boron, the metal-containing vapor including a component selected from the group consisting of dysprosium, terbium, iron and alloys thereof; and
forming a permanent magnet from the coated powder.

2. The method of claim 1 wherein the permanent magnet includes from about 0.01 to about 8 weight percent dysprosium and/or terbium.

3. The method of claim 1 wherein the metal-containing vapor is heated.

4. The method of claim 1 wherein the metal-containing vapor is contacted with a plasma to induce coating of the powder.

5. The method of claim 4 wherein the plasma is generated by microwave or radio frequency radiation to induce coating of the powder.

6. The method of claim 1 wherein the metal-containing vapor is contacted with light to induce coating of the powder.

7. The method of claim 6 wherein the metal-containing vapor is contacted with ultraviolet light to induce coating of the powder.

8. The method of claim 6 wherein the metal-containing vapor is heated.

9. The method of claim 1 wherein the metal-containing vapor comprises a component selected from the group consisting of DyCl₃, TbCl₃, DyBr₃, TbBr₃, DyI₃, TbI₃, DyF₃, Dy₂S₃, TbF₃, Tb₂S₃, Dy(2,2,6,6-tetramethyl-3,5-heptanedione)₃, Tb(2,2,6,6-tetramethyl-3,5-heptanedione)₃, pi-arene Dy complexes, and pi-arene Tb complexes.

10. The method of claim 1 wherein the metal-containing vapor is contacted with hydrogen.

11. The method of claim 1 wherein the coating has a thickness from about 10 nm to about 1000 microns.

12. The method of claim 1 wherein the permanent magnet is formed using a powder metallurgy process.

13. The method of claim 1 wherein the permanent magnet is formed by sintering.

14. The method of claim 13 wherein the coated powder is shaped by placing the coated powder into a mold.

15. The method of claim 13 wherein the coated powder is pressed under a magnetic field during shaping, and undergoes isostatic pressing or shock compaction if higher density required.

16. The method of claim 1 wherein the powder is hydrogen decrepitated before coating.

17. A method of making a magnet, the method comprising:
contacting a powder with a metal-containing vapor, the powder including neodymium, iron, and boron, the metal-containing vapor including a component selected from the group consisting of dysprosium, terbium, iron and alloys thereof;
irradiating the powder and/or the metal-containing vapor with light to induce formation of a coated powder; and
forming a permanent magnet from the coated powder.

18. The method of claim 17 wherein the metal-containing vapor comprises a component selected from the group consisting of DyCl₃, TbCl₃, DyBr₃, TbBr₃, DyI₃, TbI₃, DyF₃, Dy₂S₃, TbF₃, Tb₂S₃, Dy(2,2,6,6-tetramethyl-3,5-heptanedione)₃, Tb(2,2,6,6-tetramethyl-3,5-heptanedione)₃, pi-arene Dy complexes, and pi-arene Tb complexes.

19. The method of claim 17 wherein the metal-containing vapor is contacted with hydrogen.

20. The method of claim 17 wherein the permanent magnet is formed using a powder metallurgy process.
